(19) United States
(12) Patent Application Publication
(10) Pub. No.: US 2006/0223043 A1
(43) Pub. Date: Oct. 5, 2006

(54) Method of providing and administering a web-based personal financial management course

(76) Inventors: Glynda P. Dancy-Edwards, Rochester, NY (US); James J. Parrillo, Rochester, NY (US)

Correspondence Address: ROBERT D. GUNDERMAN, JR.;PATENT TECHNOLOGIES, LLC, 150 LUCIUS GORDON DRIVE, SUITE 205, WEST HENRIETTA, NY, 14586, US

(21) Appl. No.: 11/388,513

(22) Filed: Mar. 24, 2006

Related U.S. Application Data
(60) Provisional application No. 60/667,231, filed on Apr. 1, 2005.

(51) Int. Cl. G09B 7/00

(52) U.S. Cl. 434/362

(57) ABSTRACT

A method of learning that uses a learning assessment process to determine an optimal way in which to deliver an educational course that best suits the optimal learning style of a specific individual. The method of learning may, in a preferred embodiment, be used to provide and administer a web-based personal financial management course.

### CROSS-REFERENCE TO RELATED PATENT APPLICATIONS

This application claims the benefit of the filing date of U.S. Provisional patent application No. 60/667,231 filed on Apr. 1, 2005.

### BACKGROUND OF THE INVENTION

1. Field of the Invention

This invention relates to a method of learning, and more specifically to a method of providing and administering a web-based personal financial management course.

2. Description of the Related Art

Methods of learning are continually being developed and refined. These varying methods of learning encompass a wide range of subject matter. As new technologies are made available, methods of learning are built around and adapted to the new technology. Often times, methods of learning are created using a given technology. For example, the widespread proliferation of the Internet in recent times has created an opportunity to deliver educational courses and educational content using the Internet. Educational courses delivered through user interaction with a web site are known to those skilled in the art. The replacement of live classroom instruction with web-based instruction makes it difficult to modify and alter the delivery of the educational course to suit the specific learning needs of the student. This is due largely to the lack of an ongoing communication and feedback mechanism between the instructor and the student. Often during the delivery of a classroom course, the instructor is able to pick up both verbal and non-verbal queues from the student, allowing the instructor to modify their course delivery to better suit the learning style of the student. This ability to adjust the course delivery to the learning style of the student provides for a better learning experience. Unfortunately, web-based educational courses that are prevalent in the prior art are not able to obtain queues from the student that can depict learning style and therefore, be used to modify the instructional delivery of a web-based course to better suit the learning style mode of the student. The present invention provides for on-line delivery of an educational course to a student that uses a method to assess an individual's learning style and utilize the obtained information to deliver an educational course that is tailored specifically to the individual's learning style. The ability to tailor a method of learning to a specific individual's learning style using software and web-based course delivery has not been taught in the prior art, and is new and non-obvious. It is an object of the present invention to provide an on-line educational course to a student that is specific to the individual's learning style. It is another object of the present invention to customize an on-line educational course to a student based on a student's answers to an assessment questionnaire. It is another object of the present invention to validate/authenticate that a student completes an on-line educational course by stopping the on-line course until the student enters a password intrinsic to personal, identifiable information. It is yet another object of the present invention to provide electronic monitoring of a students progress in an on-line educational course. It is yet another object of the present invention to provide an on-line educational course to a student that includes the ability to send electronic messages between the student and a third party.

### BRIEF SUMMARY OF THE INVENTION

A method for providing an on-line educational course to a student, comprising the steps of delivering an on-line assessment questionnaire to the student, requesting that the student complete the on-line assessment questionnaire, processing the student's answers to the on-line assessment questionnaire to determine an optimal learning style of the student, using the optimal learning style of the student to determine a structure of the on-line educational course, and providing the on-line educational course to the student in a structure that is best suited to the learning style of the student.

The foregoing paragraph has been provided by way of introduction, and is not intended to limit the scope of the following claims.

### BRIEF DESCRIPTION OF THE DRAWINGS

The invention will be described by reference to the following drawings, in which like numerals refer to like elements, and in which:

FIG. 1 is an input-output diagram of a web-based course according to one embodiment of the present invention;

FIG. 2 is a functional block diagram of a web-based course according to one embodiment of the present invention;

FIG. 3 is a flowchart of a setup module according to one embodiment of the present invention;

FIG. 4 is a flowchart of a billing module according to one embodiment of the present invention;

FIG. 5 is a flowchart of a notification module according to one embodiment of the present invention;

FIG. 6 is a flowchart of a learning assessment module according to one embodiment of the present invention;

FIG. 7 is a diagram depicting various learning styles of individuals;

FIG. 8 is a flowchart of a course content module according to one embodiment of the present invention;

FIG. 9 is a flowchart of a testing module according to one embodiment of the present invention;

FIG. 10 is a flowchart depicting course progression according to one embodiment of the present invention;

FIG. 11 is a flowchart of a practical application module according to one embodiment of the present invention;

FIG. 12 is a screenshot of a home page according to one embodiment of the present invention;

FIG. 13 is a screenshot of a web page according to one embodiment of the present invention;

FIG. 14 is a screenshot of a third party access point web page according to one embodiment of the present invention; and

FIG. 15 is a screenshot of a third party monitoring point web page according to one embodiment of the present invention.

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by this specification and the appended claims.

### DESCRIPTION OF THE PREFERRED EMBODIMENTS

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

For a general understanding of the present invention, reference is made to the drawings. In the drawings, like reference numerals have been used throughout to designate identical elements.

The present invention uses a method to deliver a course that is specific to an individual's learning style or optimal learning mode. The method of the present invention relates to interaction between an individual and a web site to determine the best method of course delivery based on the individual's learning style, and delivering the course through the web site utilizing the user's optimal mode of learning. The course is delivered in a way that is tailored to the individual's unique learning style. In one embodiment of the present invention, the course is a personal financial management course. While the various objects of this invention have been described in conjunction with the embodiment of a personal financial management course, other courses may use the method of the present invention without departing from the spirit and broad scope of the invention.

It is further anticipated by the applicants that some or all components of the web based course may be administered at an educational facility or other facility suited to the administration of courses and testing. In addition, some components of the web based course may be omitted or modified. For example, to ensure integrity of the testing process, the delivery and administration of testing may be performed at a physical location. These implementation details may be modified over time, and will be known to those skilled in the art. The implementation of the present invention may vary based on specific situations and circumstances. These implementation details, do not, however, depart in any way from the spirit and broad scope of the present invention.

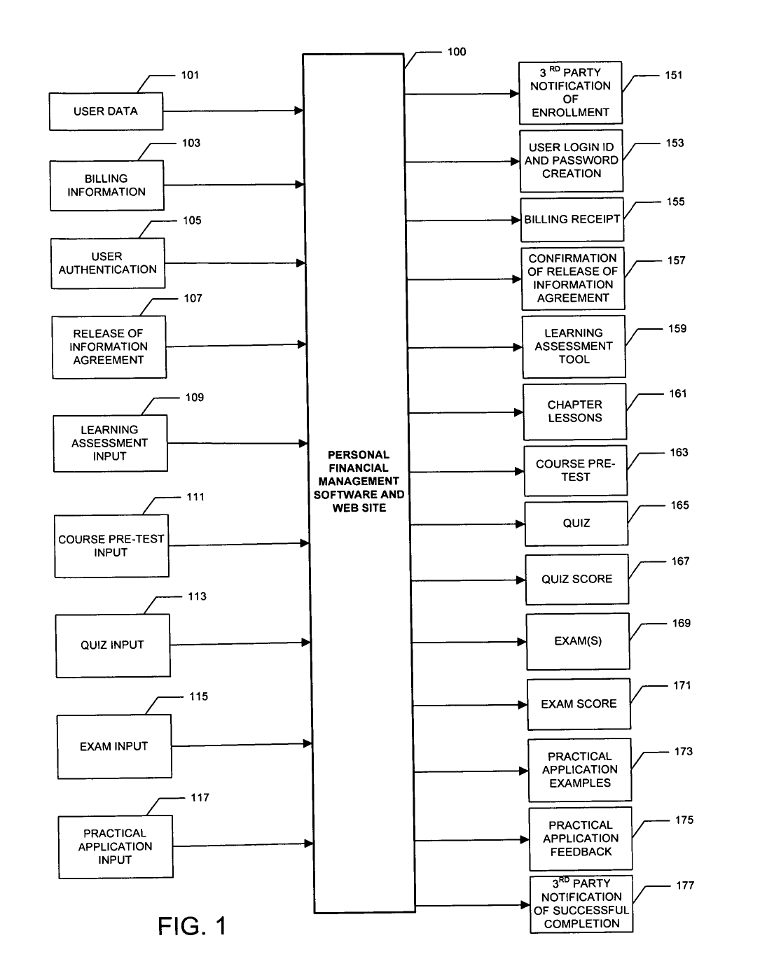

FIG. 1 is an input-output diagram of a web-based course according to one embodiment of the present invention. Referring to FIG. 1, a personal financial management software and web site element 100 is shown. Current changes in the area of bankruptcy law now require credit counseling and education for bankruptcy filers. In 2004, there were 1.5 million personal bankruptcy filings. There is now mandatory personal financial management training and education for filers of personal bankruptcy. The training and education may be, in some instances, delivered using the Internet. Unfortunately, individuals have many different learning styles, which make Internet based delivery of a fixed course problematic. In a classroom setting, a good instructor makes adjustments to the delivery of the course based on the perceived learning styles of individuals in the classroom. With delivery of a course over the Internet, such personal interaction and adjustments are not possible. This shortcoming is present with the delivery of any course over the Internet, and not just a personal financial management course. The applicants believe their Internet based learning method is applicable to all Internet based courses, and represents a significant improvement to all online courses. The learning method is described in conjunction with delivery over the Internet, but the course may also be delivered electronically through a Compact Disc or other digital storage media.

Referring again to FIG. 1, a personal financial management software and web site 100 is shown. The various inputs to the software and website 100 are shown on the left side of FIG. 1, and the various outputs to the software and website 100 are shown on the right side of FIG. 1.

The inputs to the personal financial management software and website 100 include user data 101, billing information 103, user authentication 105, release of information agreement 107, learning assessment input 109, course pre-test input 111, quiz input 113, exam input 115 and practical application input 117.

User data 101 is entered at the onset of interaction with the personal financial management software and website 100. A request for user data 101 is provided by the personal financial management software and website 100 through the use of fill in screens and prompts that are commonly known to those skilled in the art. User data 101 may include the bankruptcy court number, attorney pin number, name, address, county, phone number, birthplace, mother's maiden name, social security number or the last four digits of the user's social security number, and other personal user data such as biometrics based information that may include, but is not limited to, fingerprint identification data, facial scan data, retinal scan data, and user specific voice recognition. With the first user interaction with the personal financial management software and website 100, complete user data 101 may be a required entry. With subsequent interaction with the personal financial management software and website 100, a limited set of user data 101 may be required to authenticate the user prior to establishing a session with the personal financial management software and website 100. The user interface of the personal financial management software and web site may be provided in multiple languages. The user may elect a preferred language prior to the start of such interaction.

A user may also be required to enter billing information 103 to allow for payment of the course. Billing information may include credit card information, billing address, third party billing information, and the like.

User authentication 105 may be required prior to commencing a subsequent session with the personal financial management software and website 100.

A user of the personal financial management software and website 100 may also be required to agree to a release of information agreement 107 that allows notices to be sent to a bankruptcy court, bankruptcy judge, attorney, or another third party. The notices may include notice of enrollment in a specified course, notice of successful course completion, and the like.

Prior to the start of an Internet based course, a user will be prompted with a series of questions known as learning assessment input 109. The learning assessment input 109 is a series of questions that the user will answer to determine the optimal learning style of the user. Examples of learning styles include visual, spatial, logical, mathematical, verbal, linguistic, interpersonal, musical, rhythmic and kinesthetic model. The information from the learning assessment input 109 will then be processed to determine the structure of the educational materials that are best suited to the user's optimal learning style.

A user will also provide course pre-test input 111 during a session with the personal financial management software and website 100. The course pre-test input 111 will be used to evaluate the user's overall knowledge of the course content areas. The course pre-test input 111 will be processed to determine the user's strengths and weaknesses in mastery of course subject materials. If the user demonstrates mastery of a knowledge baseline, the user may be allowed to expedite the course by taking pre-quizzes at the beginning of each chapter lesson. In addition, the course pre-test will assess the areas where an increased speed of delivery of course materials may be applied in areas where the user already has a mastery of the subject matter. The course pre-test input 111 may also be used to assess areas of concern where the user does not have mastery of course subject matter. These areas of concern may be highlighted for the user at a normal or slower learning pace, whereas other course subject areas may be provided to the user at a modified or faster learning pace.

During a course, a user provides quiz input 113 by taking a quiz at the end of each chapter lesson. The outcome of the quiz determines the progression of the user to the next chapter. It also can depict the need for further review of information.

During a course, a user also provides exam input 115 by taking an exam at the end of each chapter and also at the end of the course. The exam input 115 is scored, with appropriate treatment being provided for a passing grade.

Practical application input 117 is provided by the user and is processed to create a series of practical application questions that are tailored to the user's demographics, credit history, and optimal learning style.

Continuing to refer to FIG. 1, the right side of the input output diagram depicts the output from the personal financial management software and web site. Once a user has completed entry of user data 101 and billing information 103, a third party notification of enrollment 151 may be generated. This notification may be provided by way of an e-mail, a hard copy letter, a facsimile transmission, or a data transfer to another computer system. Third party notification of enrollment 151 may be used as part of the overall administration of the personal financial management course, and may be provided to third parties such as judges, the courts, attorneys, and other third parties. Once a user has completed entry of user data 101 and billing information 103, the personal financial management software and web site 100 will generate a user login ID and password creation 153. This security information will allow a user to re-enter the personal financial management software and web site 100 on a recurring basis. In addition, once a user has completed entry of billing information 103, a billing receipt 155 is generated. Additionally, upon acknowledgement by the user of the release of information agreement 107, a confirmation of release of information agreement 157 is generated to the user by the personal financial management software and web site 100.

A learning assessment tool 159 is provided by the personal financial management software and web site 100 to assist with tailoring the course to the optimal learning style of the user. The learning assessment tool 159 is dynamically created by the personal financial management software and web site 100 using input data from the learning assessment input 109. The learning assessment tool 159 also provides a mechanism to tailor the chapter lessons 161 to the optimal learning style of the user. The learning assessment process and algorithm may be used with a personal financial management course or may be used with other courses and educational material provided over the Internet or in person. The chapter lessons 161 are provided in the optimal learning style of the user, with the overall content of the chapter lessons being defined by federal guidelines as well as other personal financial management information.

In conjunction with the course pre-test input 111, a course pre-test 163 may be provided to certain users that meet established criteria. The personal financial management software and web site 100 will generate a quiz 165 at the end of each chapter lesson to evaluate the progress of the user in the course. The quiz 165 is based on quiz input 113, and may be tailored to the unique learning style of the user through the use of the learning assessment input 109 and the learning assessment tool 159. The quiz 165 will be scored by the personal financial management software and web site 100, and will generate a quiz score 167. At specified points in the course, including the completion of the course, an exam or exams 169 will be provided to assess the assimilation of the course by the user. The exams 169 may further include practical application examples 173 that are correlated with the chapter lessons 161 and practical application input 117. The user will be provided with a number of these exams 169 prior to taking the formal exam. Upon successful completion of the formal exam by attaining a passing grade, third party notification of successful completion 177 will be generated for the user. This notification may be provided by way of an e-mail, a hard copy letter, a facsimile transmission, or a data transfer to another computer system. Third party notification of successful completion 177 may be used as part of the overall administration of the personal financial management course, and may be provided to third parties such as judges, the courts, attorneys, and other third parties.

At certain points in the administration of the course, practical application examples 173 may be provided to reinforce learning concepts. The practical application examples 173 are tailored to the user's demographics, credit history, and geographic location through input provided from the practical application input 117 and user data 101. The practical application examples 173 are real world applications of specified course content. The practical application examples 173 may be tailored to the user's unique learning style through the use of the learning assessment algorithm contained in the personal financial management software and web site 100. Practical application feedback 175 may also be provided to the user as part of the practical application examples 173 to further reinforce the course material.

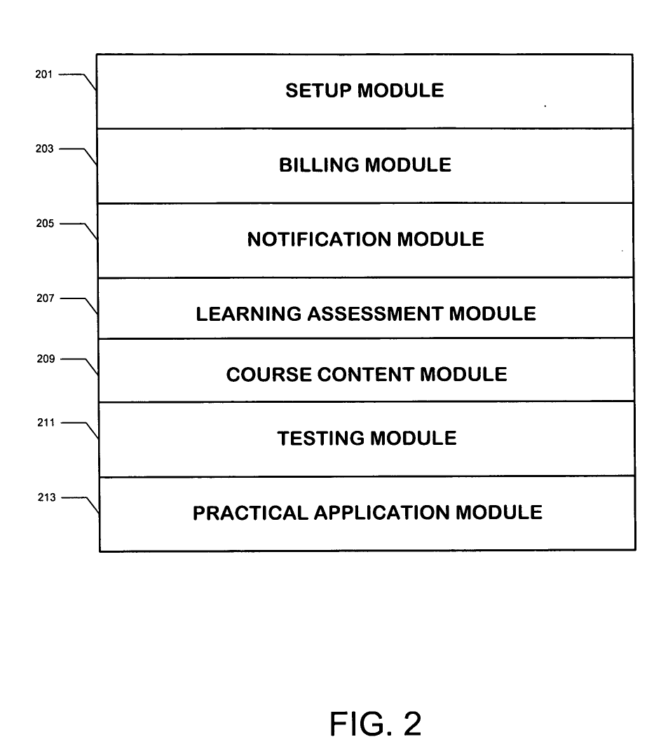

Referring now to FIG. 2, a functional block diagram of a web-based course according to one embodiment of the present invention is shown. The personal financial management software and web site 100 contains modules that perform specific functions in the delivery and administration of an Internet based course. Various embodiments may use some or all of the modules. The modules may be modified by one skilled in the art without departing from the spirit and scope of the present invention.

The setup module 201 contains data entry screens, data processing and data storage required to establish a new user in the personal financial management software and web site 100. The setup module 201 provides a graphical user interface, and may request from the user information that may include the bankruptcy court number, attorney pin number, name, address, county, phone number, birthplace, mother's maiden name, social security number or the last four digits of the user's social security number, and other personal user data such as biometrics based information that may include fingerprint identification data, facial scan data, retinal scan data, and user specific voice recognition.

The billing module 203 contains data entry screens, data processing and storage, as well as interfaces to other financial systems such as credit card payment processing systems, banking systems, and the like. The billing module provides a graphical user interface, and may request from the user information that may include method of payment, credit card or debit card information, third party billing information, direct billing information, and the like. The billing module 203 is integrated with other modules. For example, the notification module 205 may, in one embodiment, release notice of course enrollment only after billing information has been completely entered by the user and verified.

The notification module 205 provides notification to third parties of specific events, such as enrollment in the course, course status request, course progress, course completion, and the like. Third parties may include judges, the courts, attorneys, and other third parties. Notification may be in the form of e-mail messaging, text based messaging, hard copy letters, facsimile transmission, third party query of the personal financial management instructional software, and the like.

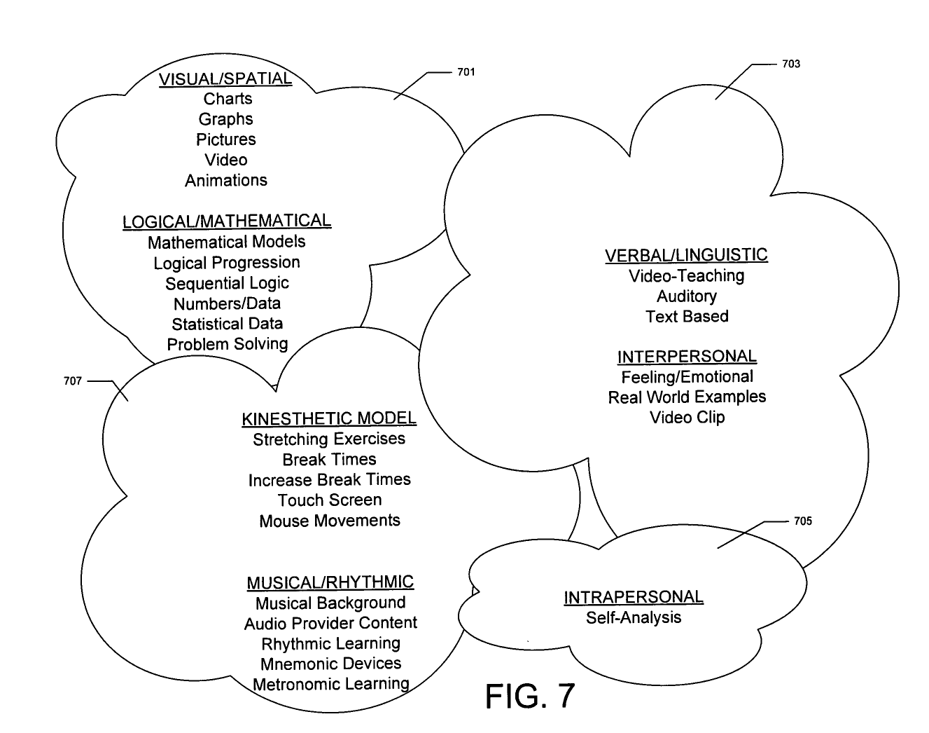

The learning assessment module 207 provides the essential processes to tailor the course to the user's unique learning style. Learning assessment processing, as further defined later in this specification and in FIG. 7, may, in some embodiments, be used to determine the optimal learning style of the user. The learning assessment module 207 provides a series of questions that the user will answer to determine the optimal learning style of the user. Examples of learning styles include visual, spatial, logical, mathematical, verbal, linguistic, interpersonal, musical, rhythmic and kinesthetic model. The user's answers to these questions will then be processed by the learning assessment module to determine the structure of the educational materials that are best suited to the user's optimal learning style.

The course content module 209 is integrated with other modules, including the learning assessment module 207. The course content module 209 contains the personal financial management course content that may be federally defined, such as chapter lessons 161 and other supplemental content such as practical application examples 173 as well as other educational materials. The course content contained in the course content module 209 may be in several formats and layouts that can be selectively administered based on criteria provided by the learning assessment module 207.

The testing module 211 may contain federally defined course exams, quizzes, tests, and the like. The testing module 211 may include various test delivery mechanisms to provide test delivery in a manner best suited to the learning style of the user. The testing module 211 provides testing instruments to the user through a secure session with the personal financial management software and web site. The testing module 211 further provides for automated scoring of administered tests, and provides the results of said scoring to the notification module 205.

The practical application module 213 contains supplemental course material. The supplemental course material may include real world examples of the main course material. The real world examples may, in some embodiments, be modified through the use of user specific data gathered through the setup module 201. These modifications may, in some embodiments, allow for the dynamic creation of real world examples that are specific to the user's geographic location, demographics, credit history, and the like. This dynamic modeling of real world examples provides additional reinforcement of the course material. In addition, the practical application module may be integrated with the learning assessment module 207 to provide real world examples that are also tailored to the unique learning style of the user through the use of learning assessment processes.

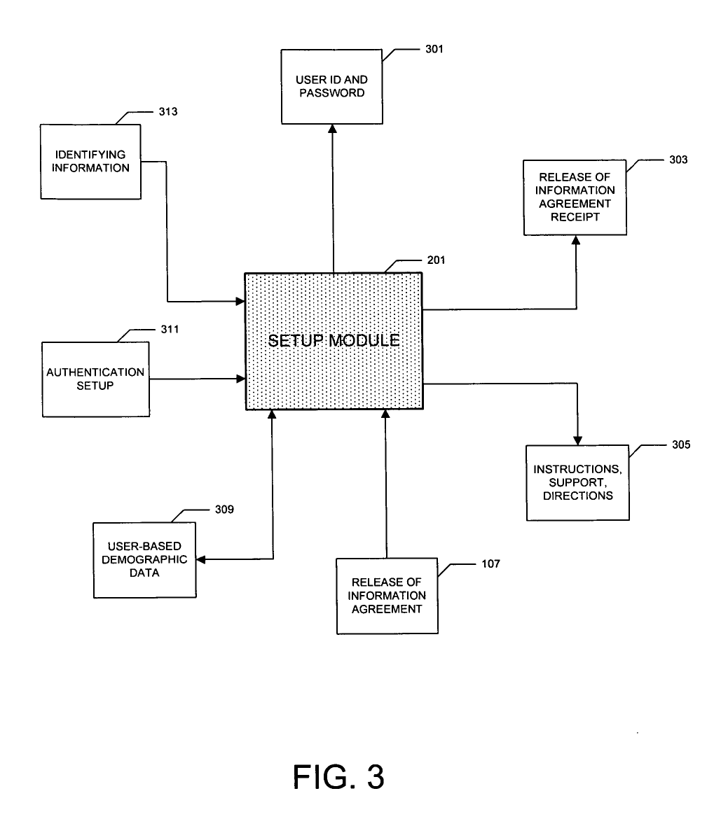

Referring now to FIG. 3, a flowchart of a setup module 201 according to one embodiment of the present invention is shown. The setup module 201 receives a release of information agreement 107 from the user that consents to the release of information to specified third parties regarding the status of the user's enrollment. Third parties may include a bankruptcy court, bankruptcy judge, attorney, or other third party. A release of information agreement receipt 303 is provided to the user in the form of an electronic receipt, a hard copy receipt, or the like. The setup module 201 provides dialogue screens to a user related to user-based demographic data 309. This data may include information such as geographic location, educational level, work history, and the like. The setup module 201 also provides an entry mechanism to allow a user to enter identifying information 313 that may include the bankruptcy court number, attorney pin number, name, address, county, phone number, birthplace, mother's maiden name, social security number or the last four digits of the user's social security number, and other personal user data such as biometrics based information that may include, but not limited to, fingerprint identification data, facial scan data, retinal scan data, and user specific voice recognition. Authentication setup 311 may also be provided to the setup module 201 that may include another level of security authentication such as an electronic key, electronic signature, encryption protocols, personal identification validation, and the like. The establishment of a User ID and password 301 is performed through the setup module, with User ID and password management and processing also occurring within the setup module. In addition to the various data entries and outputs that are processed by the setup module, instructions, support and directions 305 may be provided. The mechanism by which the instructions, support and directions 305 are provided may include online help, an electronic instruction manual, on line interactive help, a telephone support line, and the like. Other mechanisms to implement instructions, support and directions 305 will be known to those skilled in the art.

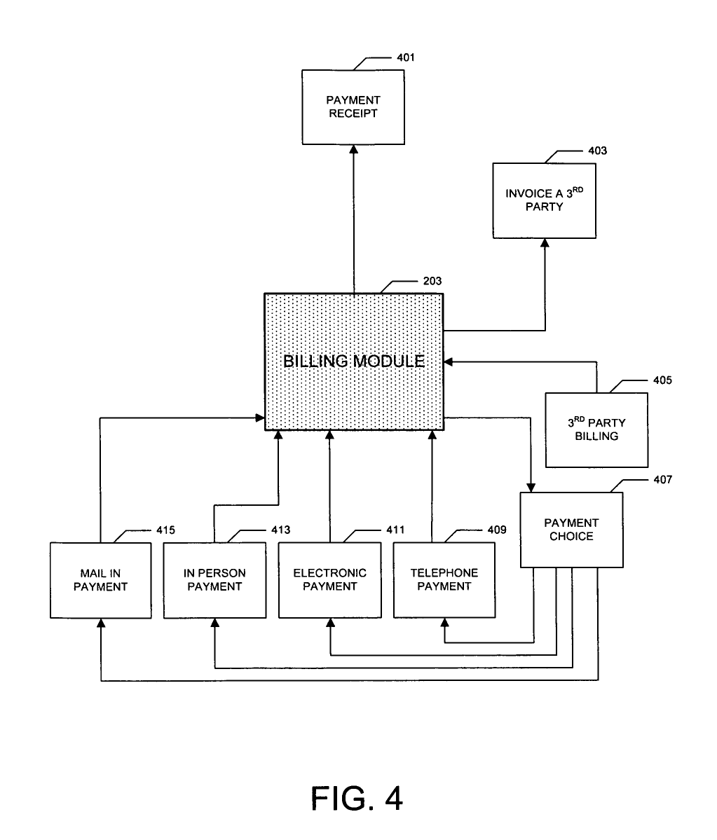

Referring now to FIG. 4, a flowchart of a billing module 203 according to one embodiment of the present invention is shown. The billing module 203 contains data entry screens, data processing and storage, as well as interfaces to other financial systems such as credit card payment processing systems, banking systems, and the like. The billing module 203 presents a payment choice 407 to the user. Payment choices may include telephone payment 409, electronic payment 411, in person payment 413, and mail in payment 415. Third party billing 405 may also be provided to the billing module 203. Third party billing 405 may, in some embodiments, be subject to verification rules and payment processing criteria that are established in the billing module 203. The billing module 203 also provides the ability to invoice a third party 403. The billing module 203 may also process payments received, for example, payments received through telephone payment 409, electronic payment 411, in person payment 413, mail in payment 415, and the like. The billing module 203 may also provide a payment receipt 401 that may be delivered electronically or with a hard copy printout, or via a facsimile transmission.

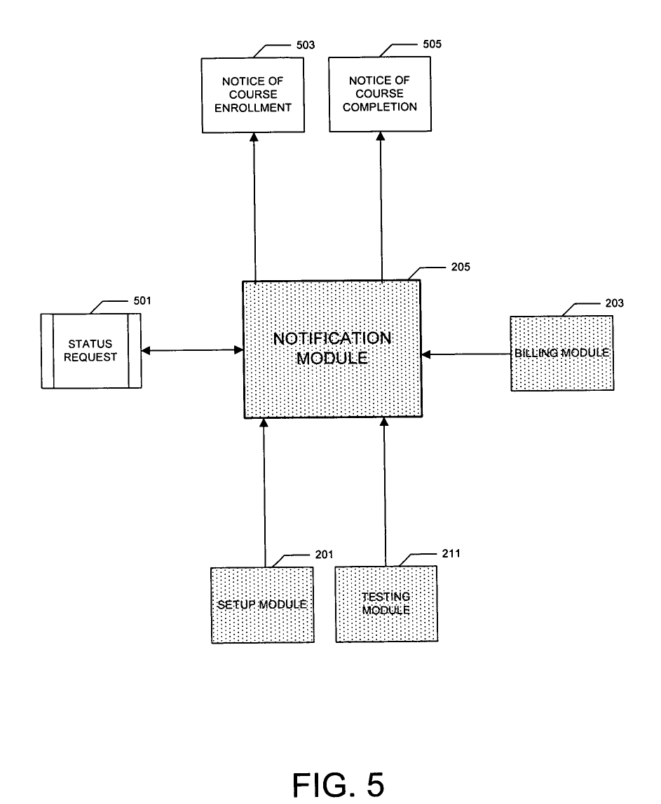

Referring now to FIG. 5, a flowchart of a notification module 205 according to one embodiment of the present invention is shown. The notification module 205 provides notification to third parties of specific events that are related to the progress of a student in a course, such as enrollment in the course, course completion, and the like. Third parties may include judges, the courts, attorneys, and other third parties. Notification may be in the form of e-mail messaging, text based messaging, hard copy letters, facsimile transmission, web site postings, and the like. Notification may also be in the form of information provided on a secure area of a web site. Notification may include information related to the progress of a student in a course, and may also, in some embodiments of the present invention, include messaging between a student and a third party. In some embodiments of the present invention, the messaging contains a priority level that is transmitted with the message. The priority level informs the receiver of the message of the urgency of the message. The notification module 205 is integrated with the setup module 201 to provide third party notice of course enrollment 503. The notification module 205 is integrated with the testing module 211 to provide third party notice of course completion 505. The notification module is integrated with the billing module 203 to allow for, in some embodiments, third party notification of specified events only upon completion of payment by the user or receipt of third party billing 405. In some embodiments, the notification module 205 may provide for a status request 501. The status request 501 may be initiated by authorized users that are specified in the personal financial management software and web site 100. The status request 501 may provide information to an authorized third party related to the course progress of a user. The status request 501 may, in some embodiments, include a notice of course progress that can be requested manually or, in some embodiments, be sent electronically.

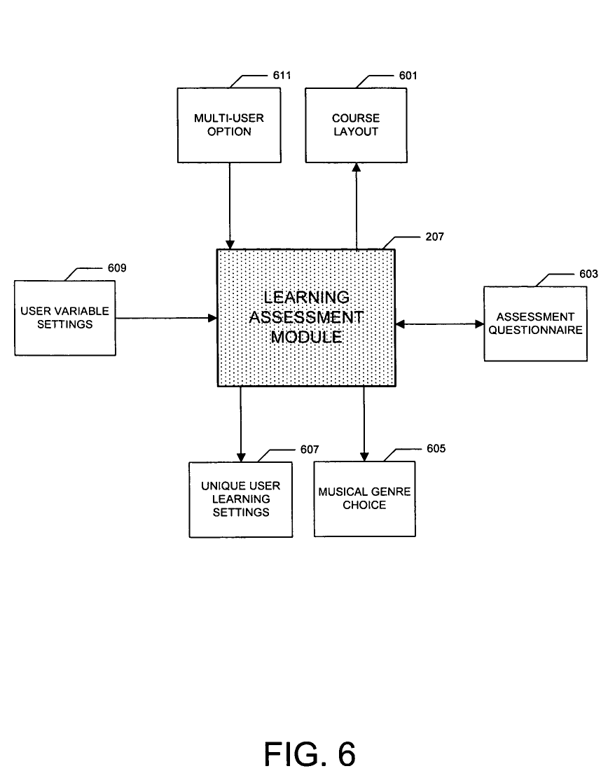

Referring now to FIG. 6, a flowchart of a learning assessment module 207 according to one embodiment of the present invention is shown. The learning assessment module 207 provides the essential processes to tailor the course to the user's unique learning style. The learning assessment, as further defined later in this specification and in FIG. 7, may, in some embodiments of the present invention, be used to determine the optimal learning style of the user. The learning assessment module 207 provides an assessment questionnaire 603 that includes a series of questions that the user will answer to determine the optimal learning style of the user. In some embodiments of the present invention, assessment questionnaires are provided to the student at various points in the learning process. Examples of learning styles include visual, spatial, logical, mathematical, verbal, linguistic interpersonal, musical, rhythmic and kinesthetic model. The user's answers to these questions will then be processed by the learning assessment module 207 to determine the structure of the educational materials that are best suited to the user's optimal learning style. The user may modify the course delivery style through user variable settings 609. In the case of multiple users, for example, a couple who has filed for bankruptcy and is required to take the personal financial management course, a multi-user option 611 may be selected to tailor the course to multiple learning styles. From the inputs gathered through the assessment questionnaire 603, and optionally the user variable settings 609, the learning assessment module 207 determines unique user learning settings 607 that are used to deliver the course consistent with the optimal learning style of the user. The course layout 601 is presented in a way that is consistent and compatible with the optimal learning style of the user. In certain embodiments of the present invention, course delivery may be optimized for certain learning styles through the addition of music. In such embodiments, a musical genre choice 605 is presented to the user.

To further illustrate one model of determining the optimal learning style of an individual, FIG. 7 shows a diagram depicting various learning styles of individuals. The multiple intelligence model is described by Howard E. Gardner in his book Multiple Intelligences: The Theory in Practice, the entire disclosure of which is incorporated herein by reference. In FIG. 7, the various learning styles as defined by the Multiple Intelligences model are depicted. 701 is a visual/spatial and logical/mathematical learning style. 703 is a verbal/linguistic and interpersonal learning style. 705 is an intrapersonal learning style and 707 is a kinesthetic model and a musical/rhythmic model. In some embodiments of the present invention, the multiple intelligences model is used to determine the optimal learning style of the user, with the course delivery being optimized to the optimal learning style of the user. Other embodiments of the present invention may use other models to determine the learning style of the user. Information regarding the optimal learning style of the user is used to determine the method of course delivery best suited to the user.

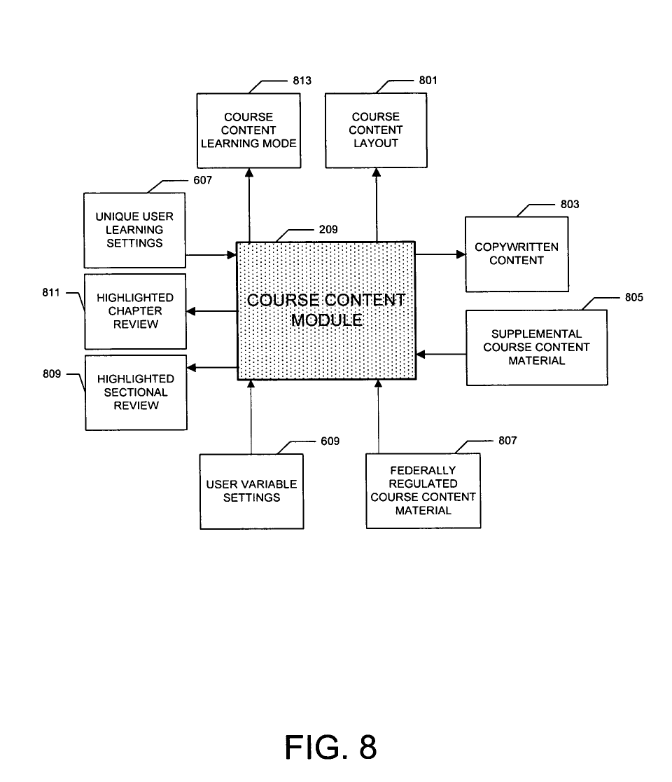

FIG. 8 is a flowchart of a course content module 209 according to one embodiment of the present invention. The course content module 209 contains material related to the final course to be delivered to a user. In one embodiment of the present invention, a personal financial management course is delivered to a user. The course content module 209 receives input from federally regulated course content material 807. Supplemental course content material 805 may be added to the course content module from a variety of sources that may provide related course materials, but are not mandated through federal regulations. Copywritten content 803 may be delivered from the course content module 209, and may include customized course content such as federally regulated course content material that has been adapted to a unique learning style. The course content module 209 receives unique user learning settings 607 from the learning assessment module 207 in order to provide a course that has been tailored to the unique learning style of the user. The user may further modify the course delivery style through user variable settings 609. The course content module 209 processes the various inputs and provides a course content layout 801 in a format that has been tailored to the unique learning needs of a specific individual. The course content learning mode 813 provides course progression customized to the unique learning needs of a specific individual. In some embodiments of the present invention, the course progression is periodically paused, with course progress resuming after the student enters a password or other personally identifiable information such as date of birth, bankruptcy case number, social security number, mother's maiden name, and the like. This ensures that the student actually views the course. In other embodiments of the present invention, a code word is spoken by the instructor or otherwise displayed during the progress of the course. The student is required to enter the code word into a form or dialogue box on a web site to validate that the student has actually viewed the course. The course content module 209 further provides for a highlighted chapter review 811 at the end of each chapter of the course, and also provides a highlighted sectional review 809 at the end of each section of the course.

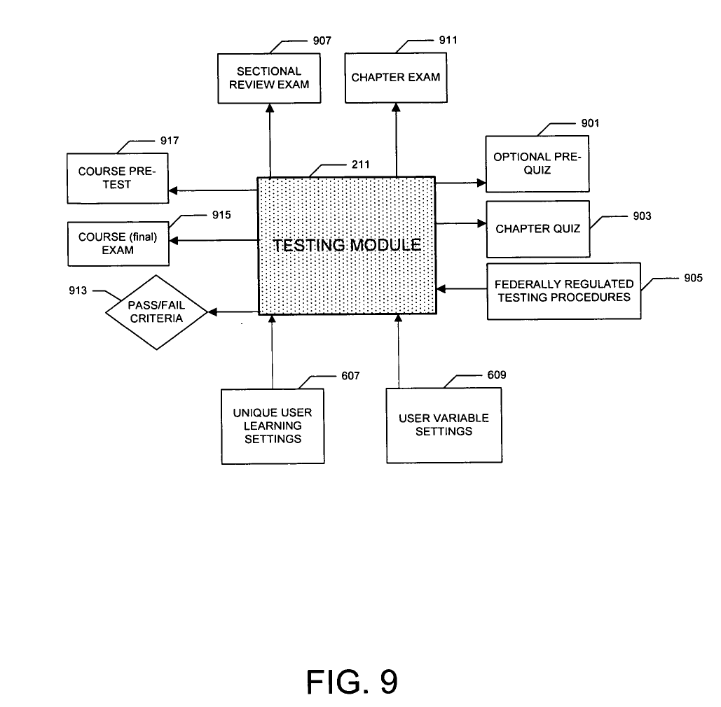

Turning now to FIG. 9, the testing module 211 is depicted. The testing module 211 takes input from federally regulated testing procedures 905. The testing module 211 receives unique user learning settings 607 from the learning assessment module 207 in order to provide testing that has been tailored to the unique learning style of the user. The user may further modify the testing delivery style through user variable settings 609. The testing module 211 processes the various inputs and provides testing in a format that has been tailored to the unique learning needs of a specific individual. An optional pre-quiz 901 may, in some embodiments, be delivered at the beginning of each chapter. A chapter quiz 903 may be delivered at the end of each chapter or at selected points throughout the chapter. A sectional review exam 907 is also provided at the end of each section, and a chapter exam 911 is provided at the end of each chapter. A course pre-test 917 may optionally be administered prior to taking the course final exam 915. The course final exam 915 is taken at the completion of the course, and upon successful completion of the course final exam 915, appropriate third party notification commences. The pass/fail criteria 913 may be provided through a federally regulated testing procedure 905, and are implemented in the testing module 211.

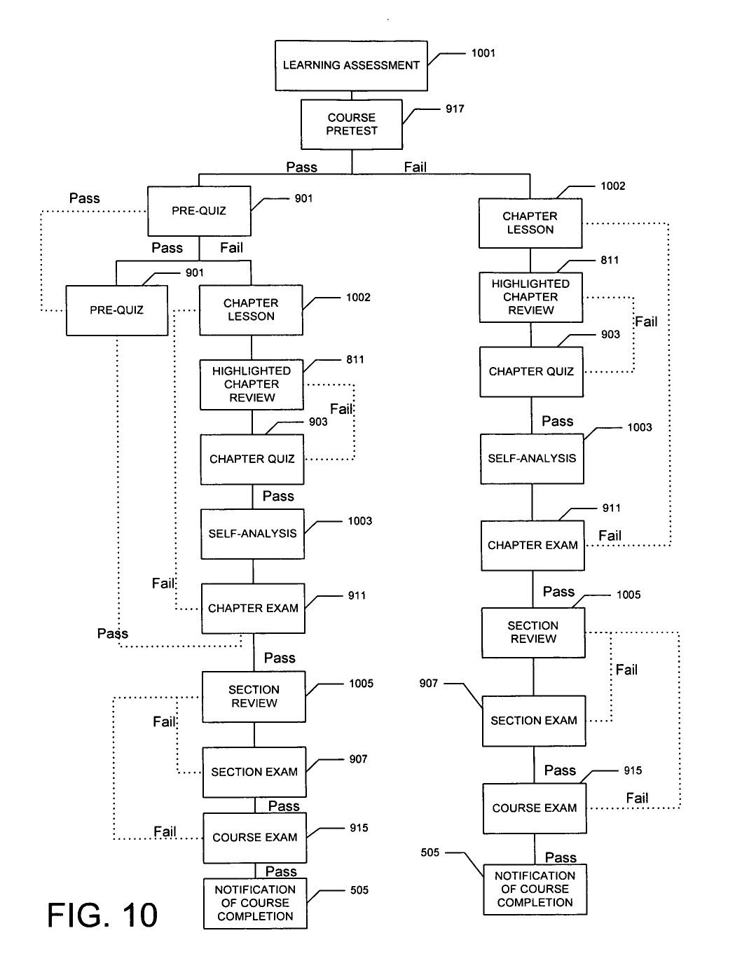

Now turning to FIG. 10, a flowchart depicting course progression according to one embodiment of the present invention is shown. Learning assessment 1001 is provided in one embodiment through an assessment questionnaire 603 that is integrated with the learning assessment module 207. Upon completion of the learning assessment 1001, a course pretest 917 is administered. Upon successful completion of the course pre-test 917, a pre-quiz 901 is administered. Upon successful completion of the pre-quiz 901, subsequent pre-quizzes are administered. If a pre-quiz is not completed successfully by obtaining a passing grade, the chapter lesson 1002 commences, with a subsequent highlighted chapter review 811, a chapter quiz 903, self-analysis 1003, and a chapter exam 911. Following the completion and testing of a chapter, a section review 1005 is administered, a section exam 907 is administered, and upon completion of all chapters and sections, a course exam 915 is administered. Upon attaining a passing grade on the course exam 915, notification of course completion 505 is provided through the notification module 205 (not shown).

Should a user fail the course pre-test 917, a chapter lesson 1002 will be delivered, with a highlighted chapter review 811, a chapter quiz 903, self-analysis 1003, and a chapter exam 911. Upon successful completion of the chapter exam 911 with a passing grade, a section review 1005 is administered, with a subsequent section exam 907. Upon completion of all chapters and sections, a course exam 915 is administered. Exams and quizzes that receive a failing grade by the user result in a re-delivery of some or all of the course content upon which the exam or quiz was based. Upon attaining a passing grade on the course exam 915, notification of course completion 505 is provided through the notification module 205 (not shown).

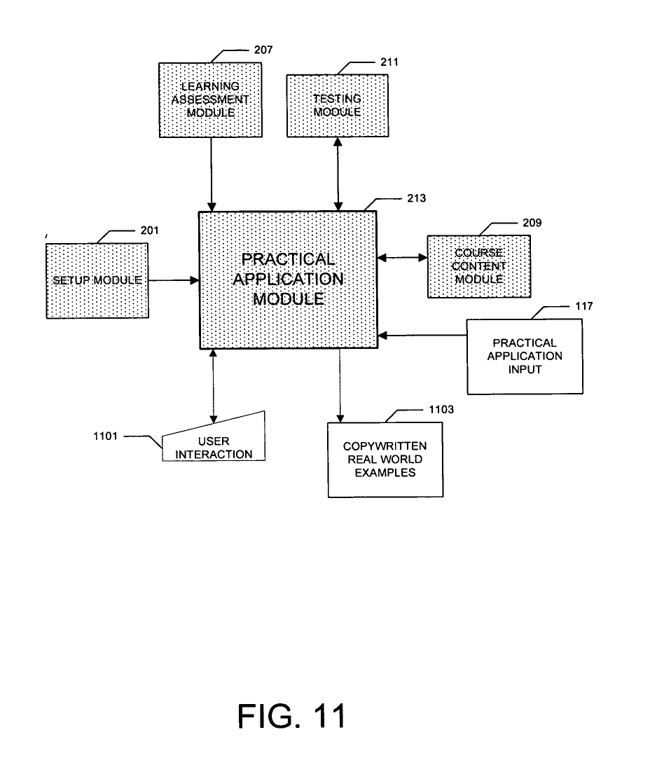

Referring now to FIG. 11, a flowchart of a practical application module 213 according to one embodiment of the present invention is shown. The practical application module 213 contains supplemental course material. The supplemental course material may include real world examples of the main course material. The real world examples may, in some embodiments, be modified through the use of user specific data gathered through the setup module 201. These modifications may, in some embodiments, allow for the dynamic creation of real world examples that are specific to the user's geographic location, demographics, credit history, and the like. This dynamic modeling of real world examples provides additional reinforcement of the course material. Practical application input 117 is provided by the user and is processed to create a series of practical application questions that are tailored to the user's demographics, credit history, and optimal learning style.

In addition, the practical application module may be integrated with the learning assessment module 207 to provide real world examples that are also tailored to the unique learning style of the user through the use of learning assessment processes. The practical application module 213 may, in some embodiments, be integrated with the testing module 211 to provide for testing using real world examples. The course content module 209 may also, in some embodiments, be integrated with the practical application module 213 to deliver course content that contains practical working examples. The practical application module 213 may include user interaction 1101 during the practical working examples. Copywritten real world examples 1103 are provided by the practical application module using inputs from various sources. The practical application module enhances the learning process and the federally mandated course content by providing an additional degree of customization to the course.

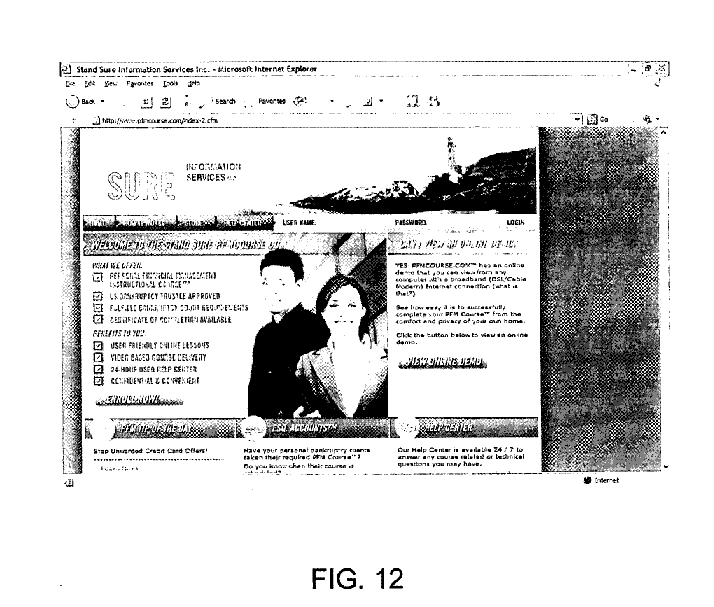

Turning now to FIG. 12, a screenshot of a home page according to one embodiment of the present invention is shown. The home page is a working example of a method of providing and administering a web-based personal financial management course.

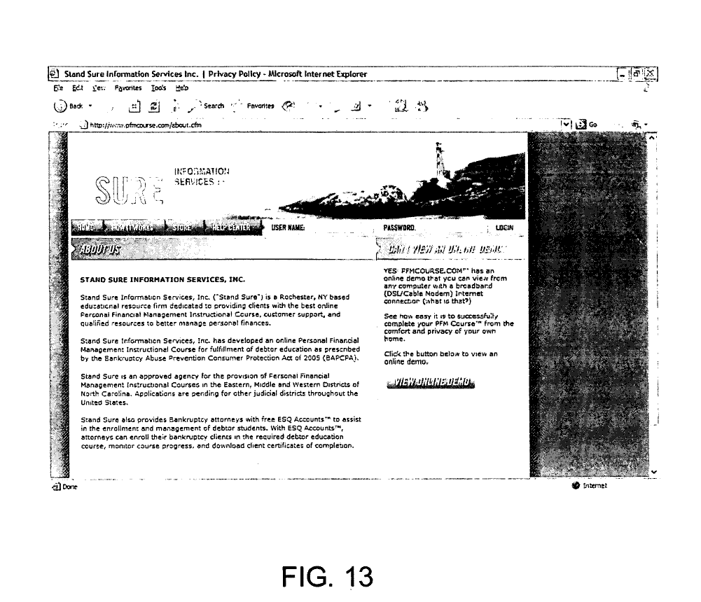

Referring now to FIG. 13, a screenshot of a web page according to one embodiment of the present invention is depicted. The web page is a working example of one of the many web pages of a method of providing and administering a web-based personal financial management course.

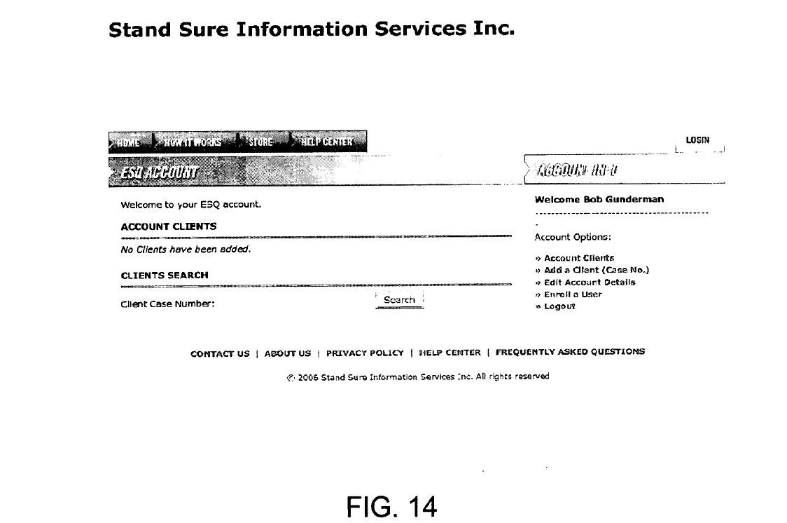

FIG. 14 shows a screenshot of a third party access point web page according to one embodiment of the present invention. The third party access point web page is a working example of the functionality described by way of FIG. 5 and the associated description contained herein.

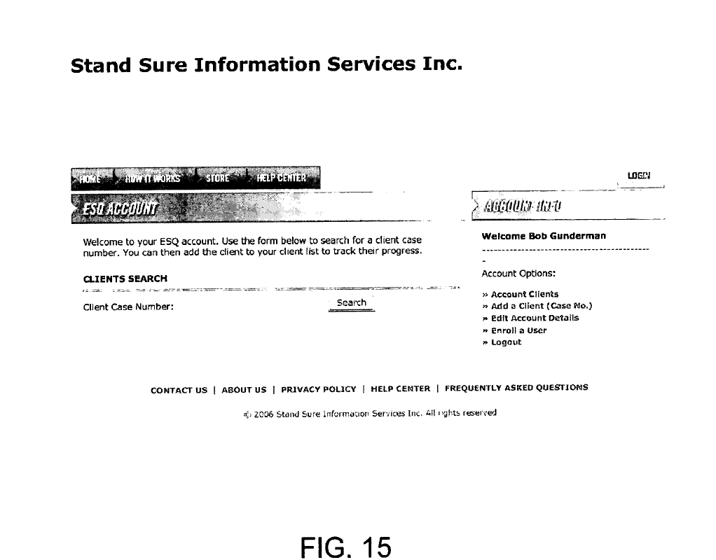

FIG. 15 depicts a screenshot of a third party monitoring point web page according to one embodiment of the present invention. The third party monitoring point web page is another working example of the functionality described by way of FIG. 5 and the associated description contained herein.

It is, therefore, apparent that there has been provided, in accordance with the various objects of the present invention, a method of providing and administering a web-based personal financial management course. While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A method for providing an on-line educational course to a student, comprising the steps of:
delivering an on-line assessment questionnaire to the student;
requesting that the student complete the on-line assessment questionnaire;
processing the student's answers to the on-line assessment questionnaire to determine an optimal learning style of the student;
using the optimal learning style of the student to determine a structure of the on-line educational course; and
providing the on-line educational course to the student in a structure that is best suited to the learning style of the student.

2. The method of claim 1, wherein processing the student's answers to the on-line assessment questionnaire comprises using a multiple intelligence model.

3. The method of claim 1, wherein processing the student's answers to the on-line assessment questionnaire is performed by a learning assessment software module.

4. The method of claim 1, further including the step of administering additional on-line assessment questionnaires while providing the on-line educational course to the student.

5. The method of claim 1, further including the step of ensuring that the student completes the on-line educational course by stopping the on-line course until the student enters a password.

6. The method of claim 1 wherein the on-line educational course is a personal financial management course.

7. The method of claim 1, further including the steps of presenting a choice of musical genre to the student and delivering the selected musical genre to the student during the delivery of the on-line educational course.

8. A method for monitoring the progress of an on-line educational course being provided to a student, the method comprising the steps of:
accessing a web site that provides on-line educational courses;
creating a third party account on the web site;
logging in to a secure area of the web site;
requesting information related to the progress of a student enrolled in an on-line educational course; and
retrieving said information.

9. A method for messaging during the delivery of an on-line educational course being provided to a student, the method comprising the steps of:
accessing a web site that provides on-line educational courses;
creating a third party account on the web site;
logging in to a secure area of the web site;
creating an electronic message to be sent to the student;
establishing a priority level for the electronic message; and
sending the electronic message to the student.

10. An information system, comprising:
a web site for providing a personal financial management course to a student;
a means for validating the completion of the course; and
a third party access point to retrieve information related to the progress of a
student enrolled in the personal financial management course.

11. The information system of claim 10, further including a learning assessment software module.

12. The information system of claim 10, further including a multiple intelligence model.

13. The information system of claim 10, further including a messaging module.
